(19) United States
(12) Patent Application Publication
(10) Pub. No.: US 2010/0100434 A1
(43) Pub. Date: Apr. 22, 2010

(54) GLOBAL ELECTRONIC RECEIPT PLATFORM FOR RECORDING, MANAGING AND ACCESSING TRANSACTION RECEIPTS THROUGH RETAILERS' PHYSICAL OR INTERNET BASED POINT OF SALE SYSTEM

(76) Inventor: Birame N. Sock, Miami Beach, FL (US)

Correspondence Address: Birame N. Sock, 50 South Pointe Drive, Apt # 1906, Miami Beach, FL, 33139, US

(21) Appl. No.: 12/253,994

(22) Filed: Oct. 19, 2008

(51) Int. Cl. G06Q 30/00; G06Q 10/00; G06F 15/16

(52) U.S. Cl. 705/14.38; 705/30; 705/24; 705/21; 709/204; 705/14.65

(57) ABSTRACT

A global electronic receipt platform for recording, managing and accessing transaction receipts through retailers' physical or internet based point of sale system. This system allows consumers to be assigned a Consumer Unique Identifier (CUI) and have retailers submit a given purchase transaction information to this global system through a secured internet connection between the retailer's point of sale system and the global electronic receipt system every time the CUI is presented. Programmed plugs-ins called Global Electronic Receipt Transfer Agents (GERTA) are made available to retailers which can be integrated into existing point of sale systems in order to process and submit electronic receipts to the Global Electronic Receipt Database Agent (GERDA). Each consumer is provided with an electronic receipt card which stores their Consumer Unique Identifier (CUI) and is presented at the time of purchase or in order to process a return, an exchange or claim a promotion such as a coupon or a rebate. This same UI is used to get access to different interfaces in order to view, manage and search through their transaction history consisting of the detailed electronic receipts generated from the different retail stores and stored in GERDA. The UI may also be linked to a credit card number and/or a phone number and/or email and/or any other loyalty card and/or any other data string accepted by the system and used to identify the consumer through the electronic receipt system in order to identify the customer at the time of purchase without the need for the electronic receipt card. Advertisers and retailers are provided with tools in order to send promotions and communicate with a selected consumer base which meets defined criteria based on the consumers' profile and purchase history stored in GERDA.

### FIELD OF THE INVENTION

The present invention relates generally to the field of systems capable of managing interactions between vendors and consumers after a transaction has been recorded. More specifically, the present invention provides a global electronic receipt platform for recording, managing and accessing transaction receipts through retailers' physical or internet based point of sale system.

### BACKGROUND OF THE INVENTION

In today's society, money can be exchanged with the click of a button; bills are sent and paid electronically through a single interface. A credit card and a formal identification is all you need to travel around the world. But why is there still billions of paper receipts being printed every year and used as the only established proof of purchase mechanism?

The average consumer is required to store and organize hundreds if not thousands of receipts every year in order to have access to a particular receipt in case of a return or exchange at a retail store, as a proof of purchase in order to receive rebates or just as a way to recall detailed information on a particular purchase on any given day. Each year, consumers scramble through their receipts in order to file their taxes and claim deductions. Traveling businessmen and women browse through boxes filled with receipts in order to accurately fill out expense reports.

The paper receipts burden goes beyond the consumer and extends itself into the retail store needing to keep records of all receipts issued, match up and validate the authenticity of receipts provided by consumers for exchanges and returns as well as manage very large amounts of paper increasing costs and processing time. And as is the case with any manual mechanism it is always prone to human error.

The internet has solved a part of this problem as web consumers now receive an email receipt and do not have to deal with storing a piece of paper. While email receipts could be implemented into physical stores as well, this solution still poses a few limitations as a) it is difficult to sort through emails of different formats and from different unfamiliar vendors, b) emails can be easily tampered with reducing their ability to serve as an authentic proof of purchase and c) emails are sometimes lost or deleted by accident or a zealous spam-filter.

While a few other proposed solutions address some of the issues discussed, most of them often require that either a) the consumer decide at the time of purchase where and how the receipt will be used in the future which is usually not known or can consist of multiple areas, b) the consumer still prints a paper copy of the receipt in order to use it as a proof of purchase and c) the consumer sort through receipts one by one from different interfaces with each retail store promoting its own delivery system and address. This limits the ability to see all receipts at once from a single interface and perform advance searches. Another big limitation to these solutions is that the retailers are not given the ability to electronically validate a particular receipt based on the consumer and the product being returned and/or exchanged which would ultimately make the transaction between retailers and consumers completely paperless.

### SUMMARY OF THE INVENTION

This invention provides a revolutionary new platform which aggregates a consumer's purchasing history and serves as proof of purchase at the retail store for returns, exchanges and rebates.

It is the answer to eliminating paper receipts and providing consumers and retailers with an easy and simple way to track and manage all their transactions. Consumers are only required to identify themselves at the time of purchase using a single universal identification, any linked credit card, loyalty card, phone number and potentially any other type of personal identification mechanism.

The invention provides retail stores an open system which can be easily integrated into any Point Of Sale (POS) solution enabling the replacement of paper receipts with an electronic system allowing for paperless transactions including purchases, returns/exchanges and coupons/rebates at the POS level, easy and secured access to archived receipt data and direct communication tools to promote products and services to any particular consumer or group of consumers.

### BRIEF DESCRIPTION OF THE DRAWINGS

FIG. 1 depicts a system diagram showing an example of data flow and what the consumer experience will be like.

FIG. 2 depicts the preferred System Architecture.

FIG. 3 describes an example of what the User Experience will look like on an electronic receipt website.

FIG. 4 depicts an example of how the customer identify is being validated at the retail outlet POS.

FIG. 5 describes the Purchasing process in a retail outlet using the present invention.

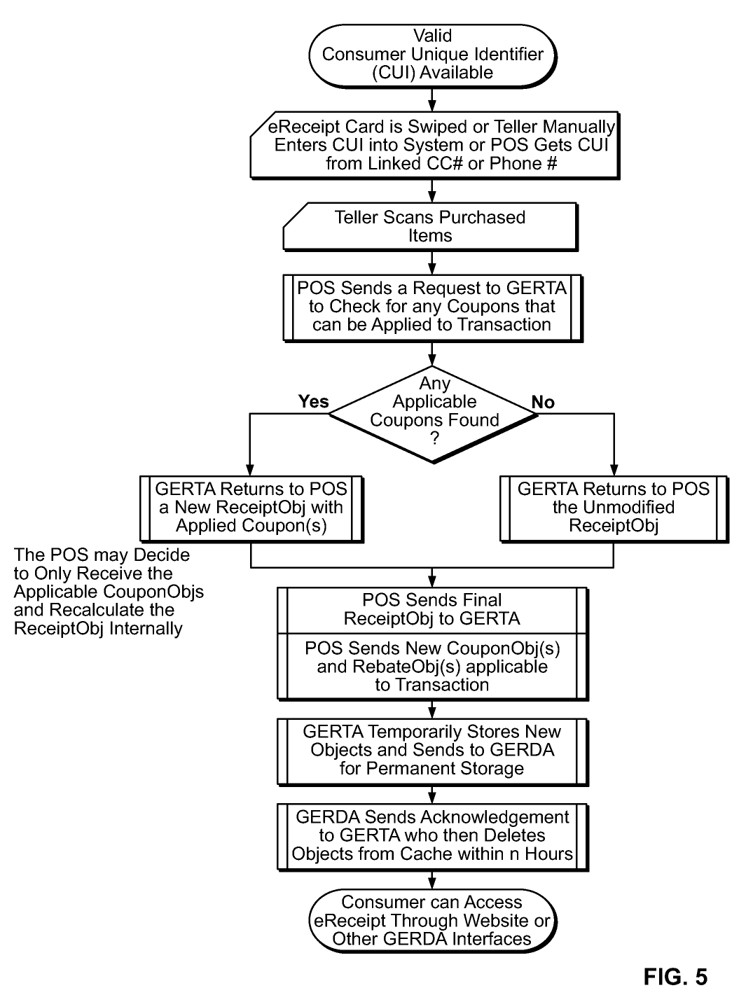

FIG. 6 gives an illustration of how a return of a purchased merchandise will be processed by a retail outlet using the present invention and therefore using electronic receipts.

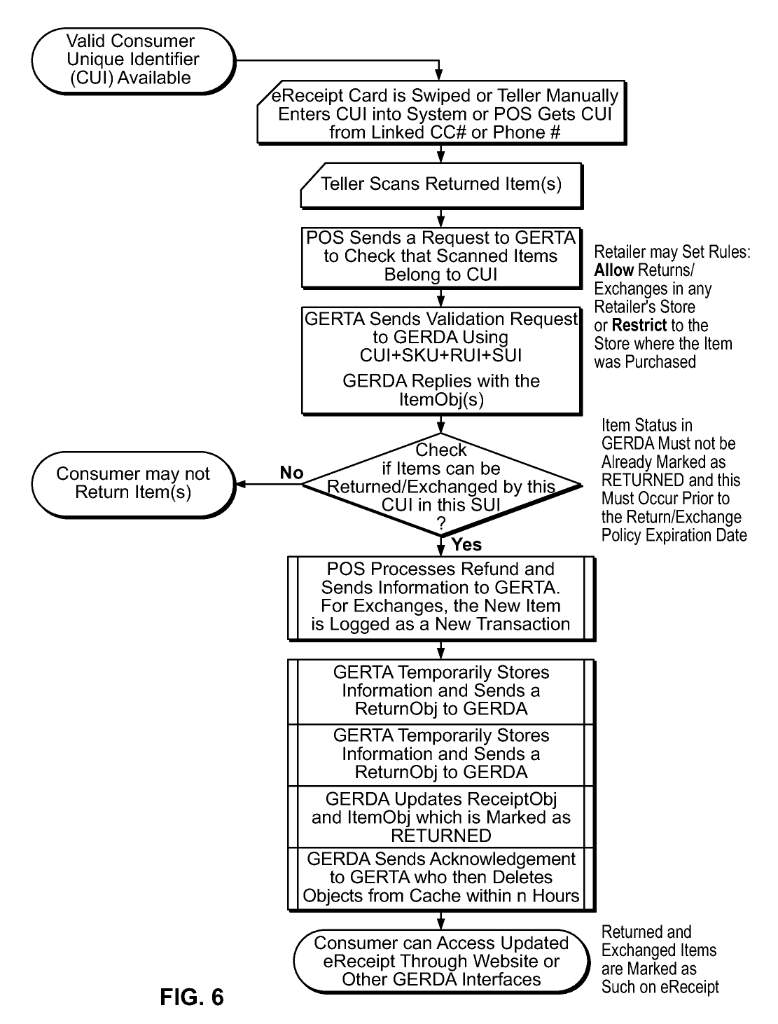

### DETAILED DESCRIPTION

The following presents a detailed description of a preferred embodiment (as well as some alternative embodiments) of the present invention. However it should be apparent to one skilled in the art that the described embodiment may be modified in forms and content to be optimized for a wide variation of situations.

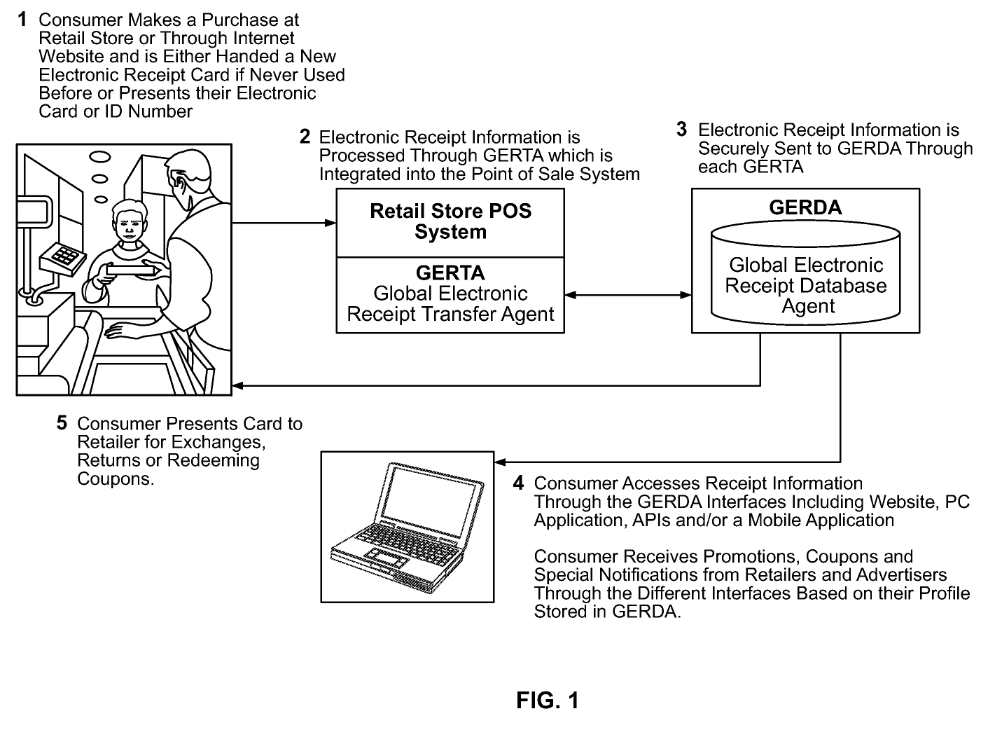

With reference first to FIG. 1, shown an example where the invention is implemented into a retailer's physical point of sale system. 1) Once the retailer has integrated the Global Electronic Receipt Transfer Agent, it can start handing out Electronic Receipt cards to new consumers. 2) Once the consumer has identified herself using an electronic receipt card or a linked card, the teller logs this information and stores all transaction information through the POS and GERTA which then 3) transfers the data through a wireline or wireless link to the Global Electronic Receipt Database Agent. The information transferred consists of the same receipt information you would find on the traditional paper receipt, any coupons and rebates attached to the transactions, any return policies or other information shared by the retail store. Data transferred also includes any system identifiers allowing for the organization of the information in the database and the future retrieval of such data. 4) Once the receipt information is stored, the consumer may access this information from a web interface after identifying themselves using the Electronic Receipt Card Identifier or the previously linked login and password.

5) If the consumer decides to return or exchange the purchased item, she will only need to re-identify herself at the store as done in Step 1 and provide the returned item (identified using its SKU). The POS interface will verify the purchase information relating to the given SKU and either approve or deny the transaction based on the response. If the consumer had been sent coupons through this system, they will be automatically redeemed during the next purchase transaction based on the consumer's account status.

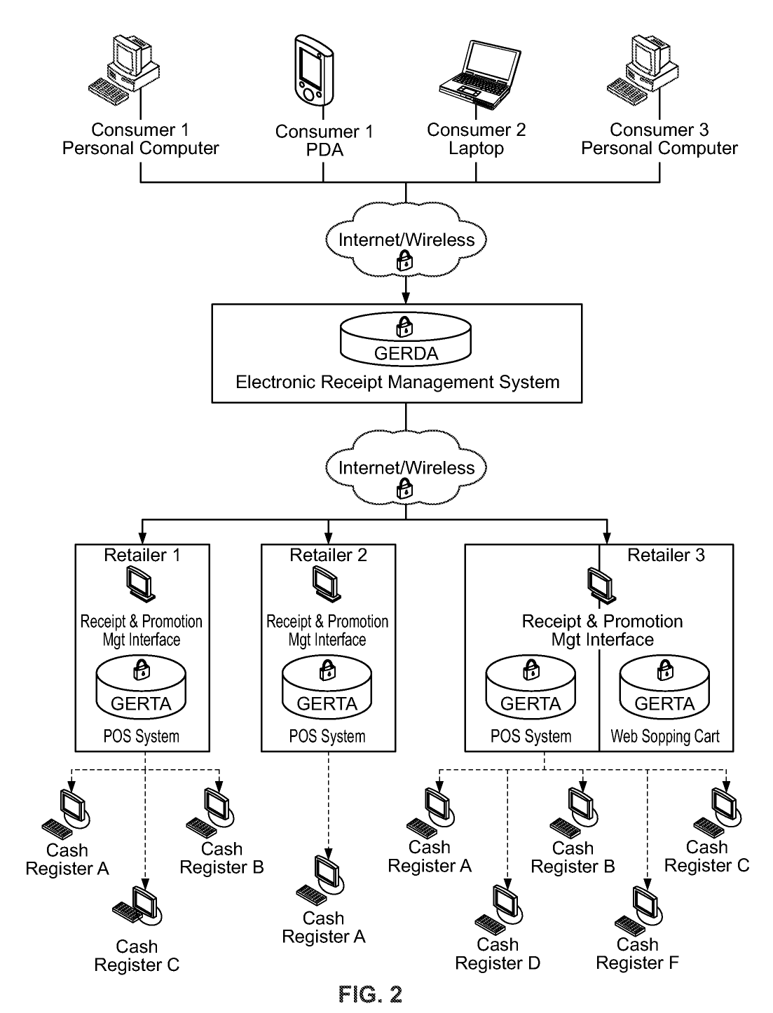

Next referring to FIG. 2, shown is the general system architecture in an environment where the invention is implemented and serves as a general overview of the different elements within a retail transaction. This diagram should be read from the bottom-up for a better understanding of the data flow. Different retailers have integrated different POS systems into their network and have a certain number of cash registers accessing the POS server. Each retailer will implement GERTA into their POS server using standardized development tools also known as APIs.

Based on the information entered through the registers, the POS system sends requests to GERTA to either retrieve (mostly for validation purposes) or transfer data from and to GERDA.

Based on the information received from GERDA, the POS system decides how such information is treated and displayed at the register level. The information is shared between GERTA and GERDA through a secured wired or wireless internet connection and a temporary copy of the data is saved into GERTA prior to being transferred in case of a connection malfunction with GERDA. Information is never deleted from GERTA until it has been transferred to GERDA.

GERDA stores all data sent from the different POS systems and uses at the minimum the Store Unique Identifier, Consumer Unique Identifier and the Transaction Unique Identifier to organize the data and make it available for future access through different interfaces. The two main organization levels in GERDA are by Store and by Consumer using the related Unique Identifiers. This type of organization allows retailers to strictly access data from their stores and see data independent from any data sent from other retailers. Consumers are also only able to pull data based on their consumer unique identifier and cannot have access to other consumer's information.

The information stored in GERDA may be accessed from different interfaces including GERTA, a personal computer connected to the internet via a wired or wireless connection or a wireless PDA or phone. The different interfaces may be any or all the following: a) a website, b) a third party application (eg: Accounting Software) or potentially through c) a specially designed device available at different stores with a constant connection to GERDA.

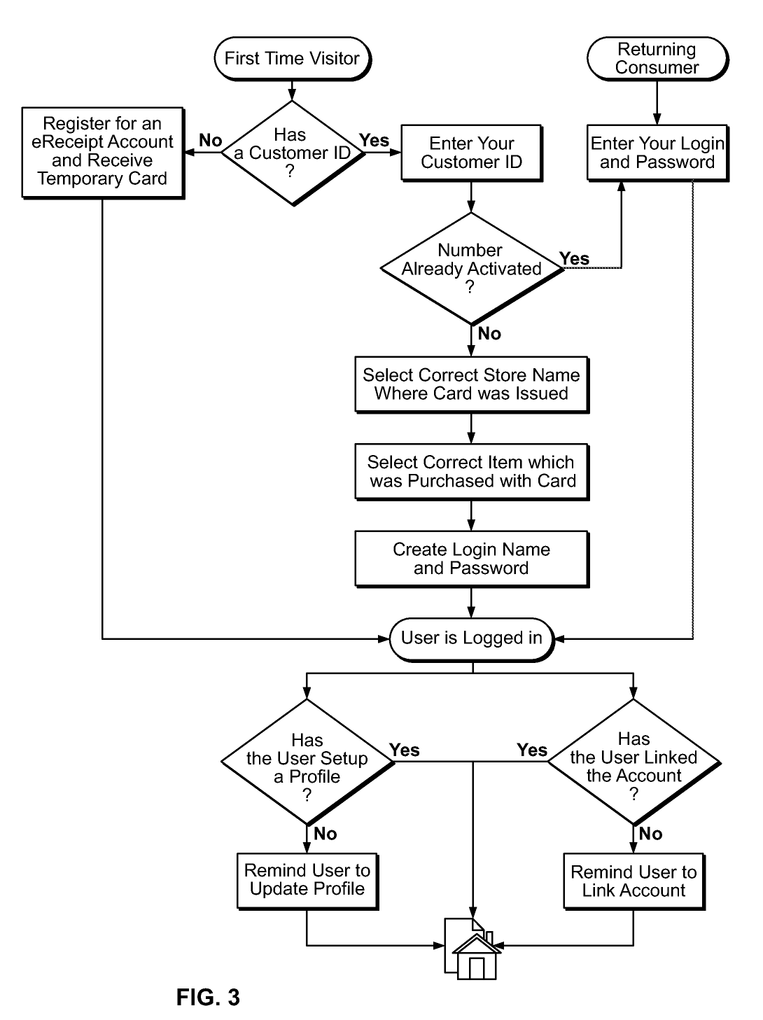

Next referring to FIG. 3, shown a flowchart depicting the different steps a consumer will need to go through in order to gain access to their electronic receipt transactions via a web interface.

Consumers visiting the site may be coming onto the site for the first time or already have an electronic receipt account setup. If the consumer has already setup an account, all they need to do is enter there previously selected login and password.

If the consumer is visiting the site for the first time and has an electronic receipt card with them which was handed to them at a retail store, once they enter the Consumer unique identifier printed on the card, they are asked to verify some information pertaining to a previous transaction made using this unique identifier. This verification process will serve as an authentication process to limit fraud by challenging individuals who try to access the site using someone else's card. This process consists of a few multiple choice questions which relate to a receipt or receipts stored in GERDA for this unique identifier. Once verified, the consumer is then asked to choose a login name and password which will be used to access the site in the future. Login names are unique within GERDA.

If the consumer is visiting the site for the first time but has never used this system before, they may create a new account on the site and are automatically assigned a unique identifier. The consumer may print their temporary electronic receipt card which can be used until a permanent card is sent to them.

Once the consumer is logged in, they are encouraged to setup their user profile and link their account with their credit cards and loyalty cards if they haven't already done it.

The user may then access the information offered on the site including the electronic receipts, coupons, rebates, store information, etc.

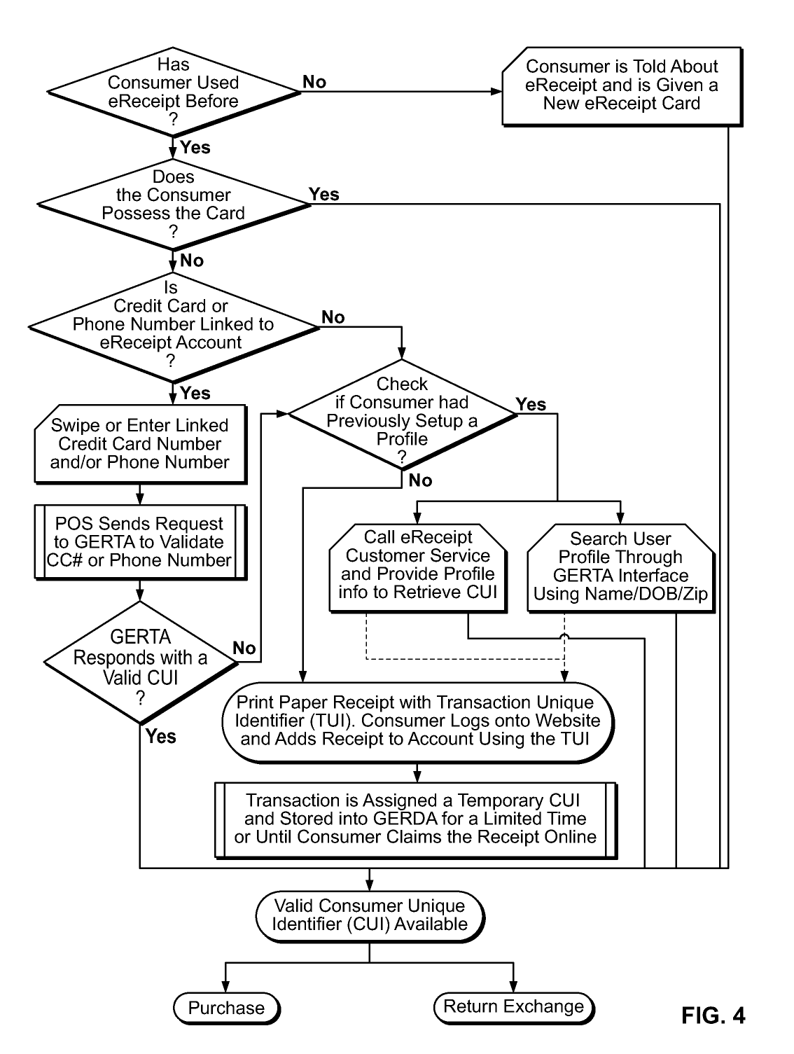

Next referring to FIG. 4, shown an example of how the customer identify is being validated at the POS station of the retail outlet. Consumers that had already established an electronic receipt account either through this same store or at another store can use the previously assigned card at the time of purchase. Consumers who had previously linked a credit card or a loyalty card to their electronic receipt account, do not need to show their electronic receipt card at the time of purchase as their Consumer Unique Identifier is automatically retrieved based on the linked identification card which was presented.

What is claimed is:

1. A global electronic receipt system for recording, managing and accessing transaction receipts through retailers' physical or internet based point of sale system, following the below defined steps of:
allowing each individual to hold a global electronic receipt card that is assigned a Consumer Unique Identifier (CUI);
providing retailers with the means to generate an electronic copy of a transaction receipt and assign a customer's CUI to each receipt using a Global Electronic Receipt Transfer Agent (GERTA);
sending the electronic receipt information to the global electronic receipt database called the Global Electronic Receipt Database Agent (GERDA);
providing multiple interfaces (including a general website) to retailers and consumers to access, manage and organize the stored electronic receipts;
aggregating and electronically applying promotions, rebates and coupons to a particular receipt through GERDA;
and providing unique tools to advertisers to promote and communicate with a selected consumer base defined by the consumer's personal profile, purchase history and notification preferences stored in GERDA.

2. The universal electronic receipt card of claim 1 in which the card is a loyalty card like card storing a CUI used to assign the card holder's information to an electronic receipt at the time of the transaction.

3. The Consumer Unique Identifier (CUI) in claim 2 in which the identifier can be linked to the card holder's credit card numbers and/or phone number and/or email or any other data string, including any other loyalty or membership program the consumer is already registered in,

4. The process of claim 3 in which the point of sale system, through an electronic link with GERDA, identifies the consumer's CUI based on the credit card used at the time of purchase or the given phone number provided by the consumer.

5. The process of claim 1 in which a Global Electronic Receipt Transfer Agent (GERTA) is integrated into a Point of Sale system in order to generate, transfer and store an electronic receipt including all transaction details which are generally printed on paper receipts.

6. The process of claim 4 in which an integrated GERTA allows the Point of Sale system to:
a) Transfer transaction information to generate and electronic receipt or transaction information
b) Transfer rebate information relating to an item on a receipt including amount, rules and any other information allowing the processing of the rebate
c) Request electronic receipt information pertaining to a particular CUI as described in claim 3 based on rules defined for each GERTA's information access privileges.
d) Request discounts and coupons applicable to transaction in order to calculate receipt total based on a given CUI
e) Update existing electronic receipt information to apply changes such as returns and exchanges
f) Request a valid CUI based on a given credit card number or phone number provided by the consumer as described in claim 4.

7. The process of claim 1 in which the Global Electronic Receipt Database Agent stores all information pertaining to a particular retailer, transaction, consumer and promotion whereas such information is accessible through different interfaces based on given access rules and privileges.

8. The process of claim 7 whereas different interfaces means a web interface, wireless application, a personal computer based program or an Application Program Interface (API).

9. The process of claim 7 whereas the information accessible through the different interfaces defined in claim 8 is based on a CUI or Point of Sale account and includes but is not limited to:
a) Electronic receipt information
b) Consumer personal information
c) Retailer information
d) Promotions and coupons
e) Rebate management
f) Other information pertaining to items already purchased such as user guides, warranty information or other documents

11. The process of claim 9 in which displayed data may be appended, modified or printed based on given access rules and privileges.

12. The process of claims 6 and 9 in which rules and privileges are managed and stored through GERDA and GERTAs.

13. The process of claim 1 in which each consumer may aggregate a certain number of coupons and promotions added to their electronic receipt account identified by the CUI and automatically processed at the time of purchase through GERTA based on the presented CUI. Discounts will be automatically calculated by the Point of Sale system through GERTA.

14. The process of claim 1 in which exchanges and returns are processed at the Point of Sale using GERTA to retrieve the electronic receipt as a proof of purchase mechanism based on the given CUI.

15. The process of claim 1 in which the retailer defines the format in which the electronic receipt is presented to the consumer on the different interfaces based on given templates which are stored in GERDA.

16. The process of claim 14 in which the retailer manages the receipt templates through the GERDA interfaces and based on given rules and privileges.

17. The process of claim 1 in which the retailers and advertisers can send promotions and messages to a set of consumers based on set of criteria managed by GERDA, whereas such messages are displayed throughout the different interfaces or sent to the consumer through electronic mail, physical mail, a wireless text message or a telephone call.

18. The process of claim 1 in which the information sent to GERDA from the Point Of Sale system is cached through GERTA in case of a connectivity failure between the two agents and transferred when the connection is functional again.

19. The process of claim 1 in which the Consumer Unique Identifier can either be entered manually into the physical or internet based POS interface or read through an existing POS card reader available at the retail store or a newly installed electronic receipt card reader.

20. The apparatus in claim 19 which consists of a card reader and a small display which allows the consumer to swipe their card and access and print information relating to their CUI which is stored in GERDA.

21. The process of claim 20 in which the apparatus is connected to GERDA via an internet connection.

22. The process of claim 20 in which the consumer must enter a password in order to authenticate the CUI.

23. The process in which the consumer that did not possess their previously assigned CUI at the time of purchase, is given a transaction unique identifier (TUI) printed on a paper receipt or displayed on a screen and can be used on the Interfaces such as a website in order to retrieve and store the electronic receipt in their account.

24. The process of claim 23 in which unidentified electronic receipts are assigned a temporary CUI and stored in GERDA.

25. The process in claim 24 in which unidentified electronic receipts are stored in GERDA for a limited time period until they expire or are assigned to a valid CUI.
